(19) United States
(12) Patent Application Publication
(10) Pub. No.: US 2008/0075979 A1
(43) Pub. Date: Mar. 27, 2008

(54) Magnetic recording medium, method of manufacturing magnetic recording medium, and magnetic recording device

(75) Inventors: Ryosaku Inamura, Kawasaki (JP); Isatake Kaitsu, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/900,888

(22) Filed: Sep. 13, 2007

(30) Foreign Application Priority Data
Sep. 27, 2006 (JP) 2006-262084

(51) Int. Cl. G11B 5/66; B05D 5/12

(52) U.S. Cl. 428/828; 427/131; 428/830

(57) ABSTRACT

An under layer, a FeCoB seed layer, a crystalline orientation control layer having an fcc structure, a non-magnetic underlying layer, a first recording layer, a second recording layer, and a protective layer are formed on a substrate. The under layer includes three layers: a first soft magnetic layer, a non-magnetic spacer layer, and a second soft magnetic layer. The first recording layer has a granular structure in which magnetic particles are dispersed in a non-magnetic material, and the second recording layer has a non-granular structure.

### CROSS-REFERENCE TO RELATED APPLICATIONS

This application is based on and claims priority of Japanese Patent Application No. 2006-262084 filed on Sep. 27, 2006, the entire contents of which are incorporated herein by reference.

### BACKGROUND OF THE INVENTION

1. Field of the Invention

The present invention relates to a magnetic recording medium for perpendicular magnetic recording, a method of manufacturing the magnetic recording medium, and a magnetic recording device in which data is magnetically recorded by using the magnetic recording medium.

2. Description of the Prior Art

In recent years, magnetic recording devices (hard disk drives) have been used not only in computers but also in video recording devices such as hard disk video recorders, portable music players, and the like. With this trend, magnetic recording devices are required to have smaller sizes and larger capacities.

In order to achieve smaller sizes and larger capacities of magnetic recording devices, the improvement of recording density is necessary. Heretofore, a typical type of magnetic recording devices has used a recording medium (a magnetic disk) for longitudinal magnetic recording in which the magnetization direction of a recording layer for recording data is an in-plane direction. In a case of magnetic recording devices of this type, however, a phenomenon occurs that recorded bits disappear due to a recording magnetic field or thermal fluctuation with an increase in the recording density of a recording medium. Thus, it is considered that the end of the increase in the density of a recording medium for longitudinal magnetic recording is being reached. For this reason, magnetic recording devices each using a recording medium for perpendicular magnetic recording (hereinafter referred to as a “perpendicular magnetic recording medium”) have been developed and put into practical use. In a case of the perpendicular magnetic recording medium, recorded bits are thermally more stable, and the recoding density can be increased more than in longitudinal recording media. In perpendicular magnetic recording media, the magnetization direction of a recording layer is the direction perpendicular to the plane of the recording layer.

As in the case of longitudinal recording media, each of perpendicular magnetic recording media is required to have resistance (thermal fluctuation resistance) to the phenomenon (i.e., thermal fluctuation) that a magnetization direction is changed by heat, and required to achieve a low magnetic noise level (low-noise performance). In order to achieve both of the thermal fluctuation resistance and the low-noise performance, it is necessary to align the directions of magnetization easy axes in a recording layer, to promote the isolation of magnetic particles in the recording layer, and to increase the coercive force of the recording layer.

However, if, merely, the isolation of the magnetic particles in the recording layer is promoted and the coercive force of the recording layer is increased, the saturation magnetic field of the recording layer is made equal to or larger than a recording magnetic field generated in a magnetic head. This deteriorates the recording performance in the recording layer, and thus results in an occurrence of a problem that the noise increases. Accordingly, it is important to increase the recording density while balancing the low-noise performance, the thermal fluctuation resistance, and the recording performance.

According to the description of Japanese Patent Application Publication No. 2001-148109, noise is reduced and reproduced output is increased by making a magnetic film for magnetic recording to have a two-layer structure including a magnetic layer made of a ferrimagnetic amorphous alloy, and a perpendicular magnetic recording layer having a higher saturation magnetization than the magnetic layer.

Japanese Patent Application Publication No. 2001-101643 describes a magnetic recording medium in which a first underlying film, a first perpendicular magnetic film, a second underlying film, a non-magnetic intermediate film, a second perpendicular magnetic film, and a protective film are stacked in this order on a substrate. According to the description of Japanese Patent Application Publication No. 2001-101643, favorable noise characteristics and thermal fluctuation resistance are obtained by setting the magnetic anisotropy energy of the first perpendicular magnetic film higher than that of the second perpendicular magnetic film.

Japanese Patent Application Publication No. Hei 11(1999)-296833 describes a magnetic recording medium in which both of an underlying film and a perpendicularly magnetized film have two-layer structures. The underlying film includes a first underlying layer having a hexagonal close-packed (hcp) or amorphous structure, and a second underlying layer having an hcp structure and a preferential growth direction along the [0001] direction. The perpendicularly magnetized film includes a lower perpendicularly magnetized layer, and an upper perpendicularly magnetized layer having a lower concentration of non-magnetic elements, a higher saturation magnetization (Ms), and a larger magnetic anisotropy energy (Kw) than the lower perpendicularly magnetized layer.

Japanese Patent Application Publication No. 2001-155321 describes a magnetic recording medium in which an under film includes first and second soft magnetic layers and a non-magnetic intermediate layer interposed in between.

Japanese Patent Application Publication No. 2005-353256 descries a perpendicular magnetic recording medium having a structure in which a soft magnetic under layer, a seed layer, an underlying layer, a recording layer, a protective layer and a lubricating layer are stacked in this order on a substrate. In Japanese Patent Application Publication No. 2001-353256, gaps are provided between crystal grains made of ruthenium (Ru) or a Ru alloy constituting the underlying layer.

A magnetic recording medium of Japanese Patent Application Publication No. 2003-77122 is formed by stacking a seed layer, a non-magnetic underlying layer, a magnetic layer, a protective layer and a lubricating layer on a substrate. In this magnetic recording medium of Japanese Patent Application Publication No. 2003-77122, the non-magnetic underlying layer is formed of a metal layer having an hcp structure, and the seed layer thereunder is formed of a metal layer having a face-centered cubic lattice (fcc) structure.

An object of Japanese Patent Application Publication No. 2004-310910 is to improve thermal fluctuation resistance. In order to achieve this object, a magnetic recording medium is described in which a magnetic layer of a perpendicular magnetic recording medium is formed of first and second layers essentially containing Co. This perpendicular magnetic recording medium of Japanese Patent Application Publication No. 2004-310910 has a characteristic that the first layer contains Pt and an oxide, and that the second layer contains Cr and no oxide.

An object of Japanese Patent Application Publication No. 2002-358617 is to improve the orientation of a magnetic recording layer. In order to achieve this object, a magnetic recording medium is described in which an underlying layer under the magnetic recording layer contains non-magnetic NiFeCr.

In Japanese Patent Application Publication No. 2004-220737, a perpendicular magnetic recording medium is described in which a granular intermediate layer made of Ru metal or a Ru alloy is provided between a soft magnetic under layer and a magnetic recording layer.

Other than the above-described ones, technologies relating to the present invention are also described in “IEEE Trans. Magn. Mag 38 (2002) 1976,” “IEEE Trans. Magn. Mag-33 (1997) 2983,” “IEEE Trans. Magn. Mag 40 (2004) 2383,” and “IEEE Trans. Magn. Mag 38 (2002) 1991.”

### SUMMARY OF THE INVENTION

According to one aspect of the present invention, a magnetic recording medium is provided. The magnetic recording medium includes a substrate; an under layer formed on the substrate and made of a soft magnetic material; a seed layer formed on the under layer and made of FeCoB; a crystalline orientation control layer which is formed on the seed layer, and which has a face-centered cubic lattice (fcc) structure; an underlying layer formed on the crystalline orientation control layer and made of a non-magnetic material; and a recording layer which is formed on the underlying layer, and which magnetically records data.

The inventors of the present application have conducted various experiments and studies in order to further improve the recording density of a perpendicular magnetic recording medium. As a result, the inventors obtained the knowledge that magnetic characteristics of a perpendicular magnetic recording medium are greatly improved when a FeCoB seed layer is formed on an under layer made of a soft magnetic material, a crystalline orientation control layer having a face-centered cubic lattice (fcc) structure is formed on the FeCoB seed layer, and a non-magnetic underlying layer and a recording layer are formed on the crystalline orientation control layer. The present invention has been made on the basis of such experiments and studies.

According to another aspect of the present invention, a method of manufacturing the magnetic recording medium is provided. The method includes the steps of: forming an under layer made of a soft magnetic material on a substrate; forming a seed layer made of FeCoB on the under layer; forming a crystalline orientation control layer having a face-centered cubic lattice (fcc) structure on the seed layer; forming an underlying layer made of a non-magnetic material on the crystalline orientation control layer; and forming a recording layer on the underlying layer.

### BRIEF DESCRIPTION OF THE DRAWINGS

FIG. 1 is a cross-sectional view showing a magnetic recording medium according to an embodiment of the present invention.

FIGS. 2A to 2C are cross-sectional views showing a method of manufacturing the magnetic recording medium according to the embodiment.

FIG. 3 is a cross-sectional view for explaining a write operation performed in the magnetic recording medium of the embodiment.

FIG. 4A is a diagram showing the result of investigating the relationship between the thickness of an fcc crystalline orientation control layer and an S/N ratio when a high-frequency signal is read, and FIG. 4B is a diagram showing the result of investigating the relationship between the thickness of the fcc crystalline orientation control layer and the S/N ratio when a low-frequency signal is read.

FIG. 5A is a diagram showing the relationship between the thickness of a FeCoB seed layer and the S/N ratio for the case where a high-frequency signal is read, and FIG. 5B is a diagram showing the relationship between the thickness of the FeCoB seed layer and the S/N ratio for the case where a low-frequency signal is read.

FIG. 6 is a diagram showing the relationship between the thickness of the FeCoB seed layer and an effective write core width (WCw).

FIG. 7 is a diagram showing the relationship between the thickness of the FeCoB seed layer and a coercive force Hc.

FIG. 8 is a diagram showing magnetization curves of recording layers.

FIG. 9 is a diagram showing the relationship between the thickness of the FeCoB seed layer and the slope α of the magnetization curve.

FIG. 10 is a plan view showing a magnetic recording device according to the present invention.

### DESCRIPTION OF THE PREFERRED EMBODIMENT

Hereinafter, an embodiment of the present invention will be described with reference to the accompanying drawings.

(Magnetic Recording Medium and Method of Manufacturing the Same)

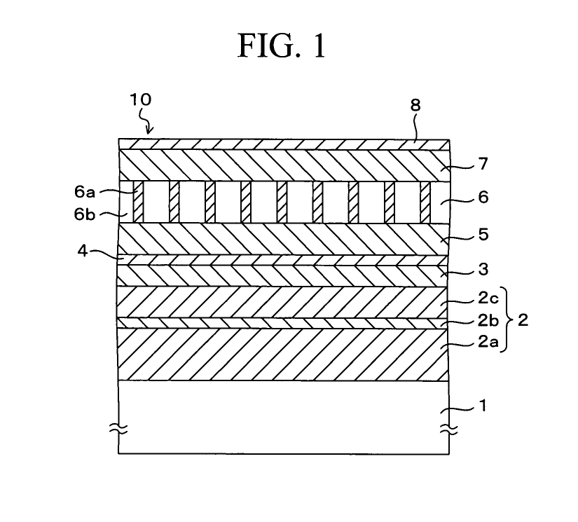

FIG. 1 is a cross-sectional view showing a magnetic recording medium according to an embodiment of the present invention. The magnetic recording medium 10 of this embodiment has a structure in which an under layer 2, a seed layer 3 made of FeCoB, a crystalline orientation control layer 4 having an fcc structure, a non-magnetic underlying layer 5, a first recording layer 6, a second recording layer 7, and a protective layer 8 are stacked in this order on a disk-shaped substrate 1 having a diameter of, for example, 2.5 inches. The under layer 2 includes three layers: a first soft magnetic layer 2a, a non-magnetic spacer layer 2b, and a second soft magnetic layer 2c. The first recording layer 6 has a granular structure in which magnetic particles 6b each having a magnetization easy axis oriented in the direction perpendicular to the substrate plane are magnetically separated by a non-magnetic material 6a, and the second recording layer 7 is made of a magnetic material having a non-granular structure.

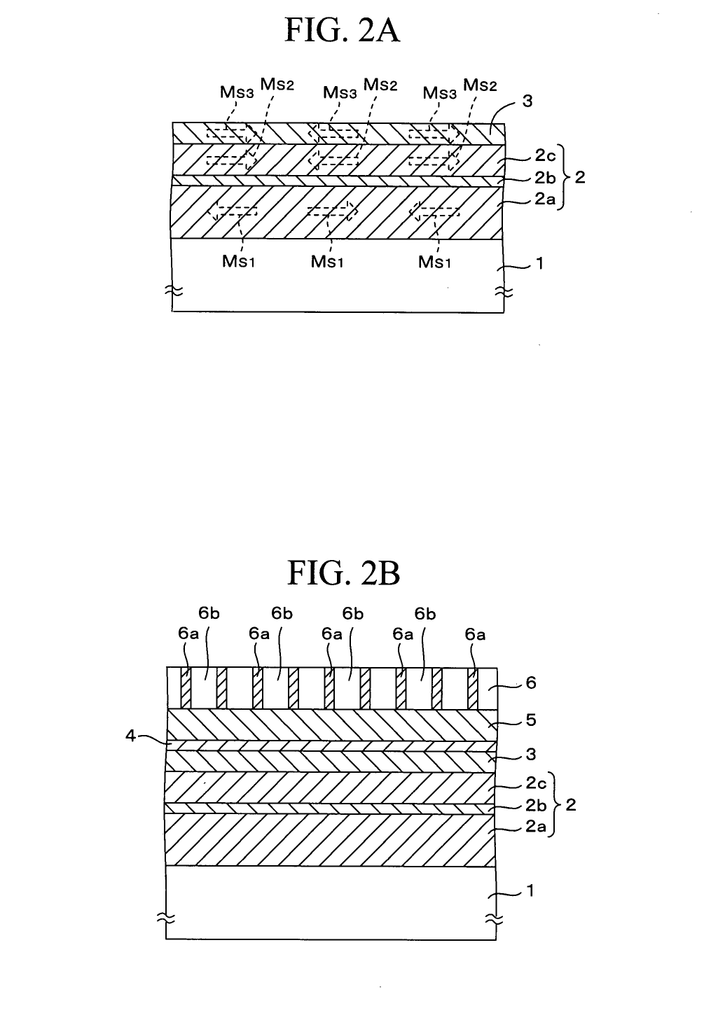

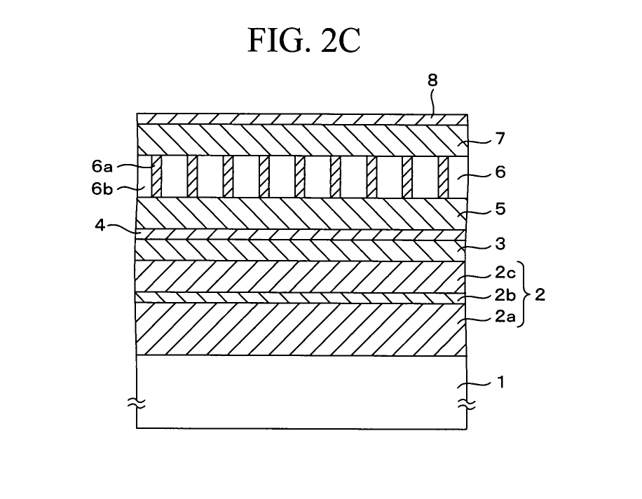

FIGS. 2A to 2C are cross-sectional views showing a method of manufacturing the magnetic recording medium 10 according to this embodiment in the processing order. By referring to these drawings, details of the magnetic recording medium 10 of this embodiment will be described.

At the beginning, steps for forming the structure shown in FIG. 2A will be described. First, the disk-shaped substrate 1 having a diameter of, for example, 2.5 inches is prepared, and a surface of the substrate 1 is plated with, for example, NiP. The substrate 1 is required to be non-magnetic and to have a flat surface and a high mechanical strength. As the substrate 1, for example, an aluminum alloy plate, a crystallized glass plate, a glass plate having a chemically-strengthened surface, a silicon substrate on whose surface a thermal oxide film is formed, a plastic plate, or the like can be used.

Next, CoNbZr is deposited on the substrate 1 to a thickness of, for example, 25 nm in an argon (Ar) atmosphere at a pressure of 0.5 Pa by direct-current (DC) sputtering using an input power of 1 kW, thus forming the first soft magnetic layer 2a having an amorphous structure.

The first soft magnetic layer 2a is not limited to the above-described CoNbZr layer. A layer made of an amorphous or microcrystalline alloy containing at least one element of cobalt (Co), iron (Fe), and nickel (Ni) and at least one element of zirconium (Zr), tantalum (Ta), carbon (C), niobium (Nb), silicon (Si), and boron (B) may be used as the first soft magnetic layer 2a. Such materials include, for example, CoNbTa, FeCoB, NiFeSiB, FeAlSi, FeTaC, and FeHfC. When consideration is given to mass productivity, the saturation magnetization of the first soft magnetic layer 2a is preferably set to approximately 1 T (tesla).

It should be noted that, though the first soft magnetic layer 2a is formed by DC sputtering in this embodiment, radio-frequency (RF) sputtering, pulsed DC sputtering, chemical vapor deposition (CVD), or the like may be employed instead of the DC sputtering. The same is true in following steps in which the DC sputtering is used.

Next, a ruthenium (Ru) layer is formed as the non-magnetic spacer layer 2b on the first soft magnetic layer 2a to a thickness of 0.7 nm in an Ar atmosphere at a pressure of, for example, 0.5 Pa by DC sputtering at an input power of 150 W. The non-magnetic spacer layer 2b is not limited to a Ru layer. A layer made of any one element of Ru, rhodium (Rh), iridium (Ir), copper (Cu), chromium (Cr), vanadium (V), rhenium (Re), molybdenum (Mo), niobium (Nb), tungsten (W), tantalum (Ta), and carbon (C), a layer made of an alloy containing at least one element of them, or a MgO layer may be used as the non-magnetic spacer layer 2b.

Subsequently, CoNbZr is deposited on the non-magnetic spacer layer 2b to a thickness of, for example, 5 nm in an Ar atmosphere at a pressure of 0.5 Pa by DC sputtering at an input power of 1 kW, thus forming the second soft magnetic layer 2c. The material constituting the second soft magnetic layer 2c is not limited to CoNbZr. As is the case with the first soft magnetic layer 2a, a layer made of an amorphous or microcrystalline alloy containing at least one element of Co, Fe, and Ni and at least one element of Zr, Ta, C, Nb, Si, and B may be used as the second soft magnetic layer 2c.

Then, a FeCoB layer having a thickness of approximately 10.5 nm is formed on the second soft magnetic layer 2c in an Ar atmosphere at a pressure of, for example, 0.67 Pa by magnetron sputtering. This FeCoB layer is used as the seed layer 3. This seed layer 3 is formed in order to control the crystal structures of the recording layers 6 and 7 in conjunction with the crystalline orientation control layer 4 formed on the seed layer 3. Since this seed layer 3 made of FeCoB has soft magnetism, it can be said that the seed layer 3 is part of the under layer 2. In this embodiment, however, a laminated body formed of three layers, which are the first soft magnetic layer 2a, the non-magnetic spacer layer 2b, and the second soft magnetic layer 2c, is referred to as the under layer 2 for convenience, and thus is distinguished from the FeCoB seed layer 3.

As described above, the under layer 2 has a structure in which two soft magnetic layers (the first and second soft magnetic layers 2a and 2c) are stacked so that the non-magnetic spacer layer 2b is interposed in between. As shown in FIG. 2A, the under layer 2 becomes stable in a state in which the saturation magnetizations Ms1 and Ms2 of the first and second soft magnetic layers 2a and 2c adjacent to each other with the non-magnetic spacer layer 2b interposed in between are opposite (antiparallel) to each other, i.e., in a state in which the first and second soft magnetic layers 2a and 2c are antiferromagnetically coupled to each other. At this time, the seed layer 3 is ferromagnetically coupled to the second soft magnetic layer 2c adjacent thereto, and the magnetization Ms3 of the seed layer 3 points in the same direction as the magnetization Ms2 of the second soft magnetic layer 2c. Such a state periodically appears with an increase in the thickness of the non-magnetic spacer layer 2b. The thickness of the non-magnetic spacer layer 2b is preferably set to a thickness that allows such a state to appear for the first time. In the case where a Ru layer is formed as the non-magnetic spacer layer 2b, the thickness thereof is set to, for example, 0.7 to 1 nm.

Since the saturation magnetization Ms1 of the first soft magnetic layer 2a and the saturation magnetization Ms2 of the second soft magnetic layer 2c become opposite (antiparallel) to each other as described above, magnetic fluxes caused by these magnetizations cancel out each other, and the total magnetic moment of the under layer 2 becomes substantially equal to zero when an external magnetic field does not exist. This results in the reduction in a leakage flux emitted from the under layer 2 to the outside, and in a spike noise caused by the leakage flux when data is read.

In the case where the saturation flux density Bs of the under layer 2 is 1 T or more, the total thickness of the under layer 2 is preferably set to 10 nm or more, more preferably 30 nm or more, from the viewpoint of ease of writing and reproduction by a magnetic head. However, since manufacturing costs increase if the total thickness of the under layer 2 is too large, the total thickness of the under layer 2 is preferably set to 100 nm or less, more preferably 60 nm or less.

In addition, if the Boron concentration in the FeCoB constituting the seed layer 3 is less than 10 at %, the effect of improving magnetic characteristics cannot be sufficiently obtained. Accordingly, the Boron concentration in the FeCoB constituting the seed layer 3 is preferably set to 10 at % or more.

The thickness of the FeCoB seed layer 3 needs to be set to 3 nm or more from the viewpoint of improving magnetic characteristics. Furthermore, when consideration is given to ease of film thickness control in mass production and electromagnetic conversion characteristics, the thickness of the seed layer 3 is preferably set to 5 nm or more. On the other hand, since manufacturing costs increase if the thickness of the FeCoB seed layer 3 increases, the thickness of the FeCoB seed layer 3 is set to 20 nm or less, more preferably 12 nm or less. Instead of the FeCoB seed layer 3, an amorphous or microcrystalline FeCo alloy layer to which at least one element of Ni, Cr, Cu, Nb, Zr, Si, Ta, and W is added may be formed to be used as the seed layer 3. Examples of such an alloy layer include a FeCoBNi layer, a FeCoBCr layer, a FeCoNd layer, and a FeCoZr layer.

It should be noted that, instead of the structure in which the first and second soft magnetic layers 2a and 2c are separated by the non-magnetic spacer layer 2b as described above, a single antiferromagnetic layer in which magnetization directions are aligned in one direction as described in “IEEE Trans. Magn. Mag-33 (1997) 2983” and “IEEE Trans. Magn. Mag 40 (2004) 2383” may be used as the under layer 2.

Next, steps for forming the structure shown in FIG. 2B will be described. After the under layer 2 and the FeCoB seed layer 3 are formed as described above, non-magnetic NiFeCr is deposited on the FeCoB seed layer 3 in an Ar atmosphere at a pressure of, for example, 0.67 Pa by sputtering, thus forming the crystalline orientation control layer 4 having a face-centered cubic lattice (fcc) structure. Since the FeCoB seed layer 3 is formed under this crystalline orientation control layer 4, the crystalline orientation control layer 4 has a favorable fcc structure regardless of the surface state of the second soft magnetic layer 2c. The thickness of the crystalline orientation control layer 4 is preferably set to 3 nm or more from the viewpoint of controlling the crystal orientations of the under layer 5 and the recording layers 6 and 7, which are formed above the crystalline orientation control layer 4.

It should be noted that the crystalline orientation control layer 4 may be formed of either a non-magnetic material or a magnetic material. In the case where the crystalline orientation control layer 4 is formed of a non-magnetic material, if the thickness thereof is too large, the distance between a magnetic head and the under layer 2 increases, and it becomes difficult to improve recording density. Accordingly, in the case where the crystalline orientation control layer 4 is formed of a non-magnetic material, the thickness thereof is set to 20 nm or less, more preferably 10 nm or less. On the other hand, in the case where the crystalline orientation control layer 4 is formed of a magnetic material, if the thickness thereof is too large, noise from the crystalline orientation control layer 4 increases, and this deteriorates an S/N ratio. Accordingly, in the case where the crystalline orientation control layer 4 is formed of a magnetic material, the thickness thereof is preferably set to 10 nm or less.

Next, a Ru layer is formed on the crystalline orientation control layer 4 to a thickness of approximately 20 nm in an Ar atmosphere at a pressure of 8 Pa by DC sputtering at an input power of 250 W. The Ru layer is used as the non-magnetic underlying layer 5. Since this Ru layer constituting the non-magnetic underlying layer 5 is formed on the crystalline orientation control layer 4 having an fcc structure, the crystal structure of the Ru layer becomes an hcp structure, and the crystallinity thereof is also favorable.

It should be noted that the non-magnetic underlying layer 5 may be formed of a layer made of an alloy containing Ru and any one element of Co, Cr, W, and Re, instead of the Ru layer. Moreover, the non-magnetic underlying layer 5 is not limited to a single-layer structure, and may be formed of two or more layers for the purpose of improving electromagnetic conversion characteristics or for other purposes, as described in, for example, the aforementioned Japanese Patent Application Publication No. 2004-220737.

Next, the first recording layer 6 is formed on the non-magnetic underlying layer 5 by DC sputtering using a target made of CoCrPt and SiO₂. The sputtering at this time is performed, for example, under the conditions that the atmosphere is an Ar atmosphere, and that the input power is 350 W. This forms the first recording layer 6 having a structure (granular structure) in which the magnetic particles 6b made of CoCrPt are dispersed in the non-magnetic material (SiO₂) 6a. The thickness of this first recording layer 6 is not particularly limited, but is set to 11 nm in this embodiment. Moreover, in this embodiment, the composition ratio (at %) of Co, Cr, and Pt constituting the magnetic particles 6b of the first recording layer 6 is set to Co:Cr:Pt=70:10:20.

Here, the non-magnetic underlying layer 5 formed under the first recording layer 6 and made of Ru has a hexagonal close-packed (hcp) crystal structure, and functions as to align the orientation of each of the magnetic particles 6b in the perpendicular direction. As a result, each of the magnetic particles 6b has an hcp crystal structure extending in the perpendicular direction as in the case of the non-magnetic underlying layer 5, and the height directions (C axis) of the hexagonal column of the hcp structure becomes a magnetization easy axis. Thus, the first recording layer 6 is made to have perpendicular magnetic anisotropy.

It should be noted that, though SiO₂ is employed as a material for the non-magnetic material 6a of the first recording layer 6 in this embodiment, an oxide other than SiO₂ may be used as a material for the non-magnetic material 6a. Such oxides include, for example, an oxide of any one element of Ta, Ti, Zr, Cr, Hf, Mg, and Al. Furthermore, a nitride of any one element of Si, Ta, Ti, Zr, Cr, Hf, Mg, and Al may be used as a material for the non-magnetic material 6a.

Moreover, an alloy containing any one metal element of Co, Ni and Fe may be used as a material for the magnetic particles 6b of the first recording layer 6, instead of the aforementioned CoCrPt.

Next, steps for forming the structure shown in FIG. 2C will be described. After the first recording layer 6 is formed as described above, a CoCrPtB layer having an hcp structure is formed as the second recording layer 7 on the first recording layer 6 to a thickness of, for example, 6 nm in an Ar atmosphere by DC sputtering at an input power of 400 W.

In this embodiment, the composition ratio (at %) of Co, Cr, Pt and B constituting the second recording layer 7 is set to Co:Cr:Pt:B=66:20:10:4. This second recording layer 7 formed on the first recording layer 6 shows perpendicular magnetic anisotropy as is the case with the first recording layer 6. Since the CoCrPtB layer constituting the second recording layer 7 has the same hcp structure as the magnetic particles 6b of the first recording layer 6 under the second recording layer 7, the second recording layer 7 having good crystallinity is formed on the first recording layer 6. It should be noted that the second recording layer 7 is not limited to a CoCrPtB layer, and that a layer made of an alloy containing at least one metal element of Co, Ni and Fe may be formed as the second recording layer 7.

In this embodiment, while the CoCrPtB constituting the second recording layer 7 contains 20 at % Cr and 10 at % Pt, the CoCrPt constituting the magnetic particles 6b of the first recording layer 6 contains 10 at % Cr and 20 at % Pt. By setting the Cr content of the magnetic particles 6b lower than that of the second recording layer 7, and by setting the Pt content of the magnetic particles 6b higher than that of the second recording layer 7, the perpendicular magnetic anisotropy of the first recording layer 6 becomes higher than that of the second recording layer 7. That is, the first recording layer 6 has a larger anisotropy field (Hk) and a smaller magnetization curve slope (α) than the second recording layer 7. As a result, the resolution of magnetic data of the first recording layer 6 becomes high, and it becomes possible to reduce a write core width. Thus, the recording density of the first recording layer 6 can be further improved.

Furthermore, the above-described Cr and Pt contents of the recording layers 6 and 7 increase the coercive force Hc of the first recording layer 6, and thus it also becomes possible to further reduce noise (e.g., transition noise) generated in the first recording layer 6.

After the second recording layer 7 is formed as described above, a diamond like carbon (DLC) layer is formed as the protective layer 8 on the second recording layer 7 to a thickness of approximately 4 nm by means of the radio-frequency chemical vapor deposition (RF-CVD) method using a C₂H₂ gas as a reaction gas. Deposition conditions for this protective layer 8 are, for example, as follows: a pressure of approximately 4 Pa, a high-frequency input power of 1000 W, a bias voltage of 200 V between the substrate and a showerhead, and a substrate temperature of 200° C.

Next, a lubricant (not shown) is spread over the protective layer 8 to a thickness of approximately 1 nm, and then surface protrusions and foreign substances on the protective layer 8 are removed using an abrasive tape. Thus, the manufacturing of magnetic recording medium 10 according to this embodiment is completed. It should be noted that the protective layer 8 and the layer of the lubricant can be formed if needed, since they are not essential components of the present invention.

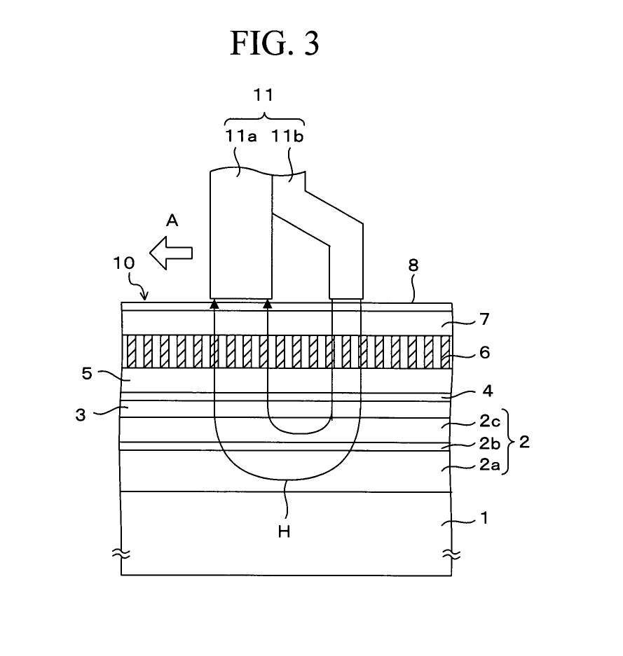

FIG. 3 is a cross-sectional view for explaining a write operation performed on the magnetic recording medium of this embodiment.

In order to write to the magnetic recording medium, the tip of a magnetic head 11 having a main pole 11b and a return yoke 11a is placed to face the magnetic recording medium 10 as shown in FIG. 3, and a signal corresponding to data to be recorded is supplied to the magnetic head 11. Then, a recording magnetic field H generated in the main pole 11b having a small cross section penetrates through the first and second recording layers 6 and 7 toward the under layer 2 in the perpendicular direction. Thus, a magnetic domain, in a portion right under the main pole 11b, of the first recording layer 6 is magnetized in the perpendicular direction by the recording magnetic field H.

The recording magnetic field H penetrates through the first recording layer 6 in the perpendicular direction, then passes through the under layer 2 in the in-plane direction, again penetrates through the first and second recording layers 6 and 7 in the perpendicular direction, and returns to the return yoke 11a having a large cross section. At this time, the magnetization directions of the first and second recording layers 6 and 7 do not change because the flux density is low.

By changing the direction of the recording magnetic field H correspondingly to the data to be recorded while moving the magnetic recording medium 10 relatively to the magnetic head 11 in the direction represented by A in the drawing, a plurality of magnetic domains magnetized in the perpendicular direction are formed to be continuous in the track direction of the magnetic recording medium 10, whereby a series of data is recorded on the magnetic recording medium 10.

As described previously, in this embodiment, the thickness of the crystalline orientation control layer 4 having an fcc structure is set to 3 nm or more. The relationship between the thickness of the crystalline orientation control layer 4 and the S/N ratio will be described below.

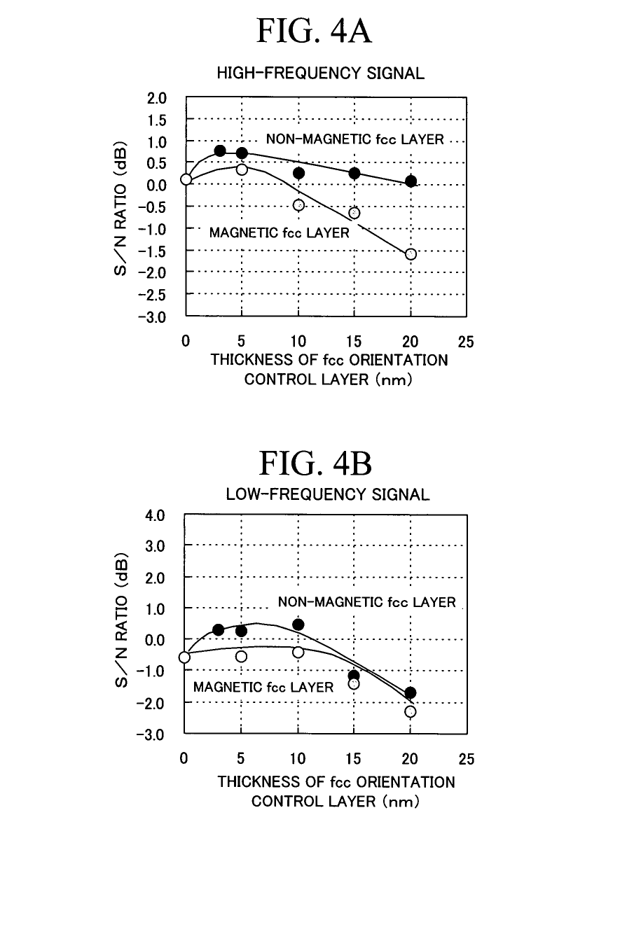

FIG. 4A is a diagram showing the result of investigating the relationship between the thickness of the crystalline orientation control layer 4 having an fcc structure and the S/N ratio, when a high-frequency signal recorded in the recording layers 6 and 7 is read by a magnetic head. FIG. 4B is a diagram showing the result of investigating the relationship between the thickness of the crystalline orientation control layer 4 having an fcc structure and the S/N ratio, when a low-frequency signal recorded in the recording layers 6 and 7 is read by the magnetic head. It should be noted that, in FIGS. 4A and 4B, the S/N ratio of a reference magnetic recording medium (a magnetic recording medium having a fcc orientation control layer with a thickness of zero in FIG. 4A) that does not include the crystalline orientation control layer 4 having an fcc structure is referenced to zero.

In the case where a high-frequency signal is read and where the crystalline orientation control layer 4 is formed of a non-magnetic material, as can be seen from FIG. 4A, the more favorable S/N ratios than in the reference can be obtained by setting the thickness of the crystalline orientation control layer 4 to be 3 to 20 nm. On the other hand, in the case where a high-frequency signal is read and where the crystalline orientation control layer 4 is formed of a magnetic material, as can be seen from FIG. 4A, the S/N ratios become lower than in the reference by setting the thickness of the crystalline orientation control layer 4 to be 10 nm or more.

In the case where a low-frequency signal is read and where the crystalline orientation control layer 4 is formed of a non-magnetic material, as can be seen from FIG. 4B, the more favorable S/N ratios than in the reference can be obtained by setting the thickness of the crystalline orientation control layer 4 to be 3 to 10 nm. On the other hand, in the case where a low-frequency signal is read and where the crystalline orientation control layer 4 is formed of a magnetic material, as can be seen from FIG. 4B, the S/N ratios become lower than in the reference by setting thickness of the crystalline orientation control layer 4 to be 10 nm or more.

For the above reason, in this embodiment, in the case where the crystalline orientation control layer 4 is formed of a non-magnetic material, the thickness thereof is set to be not less than 3 nm nor more than 20 nm (more preferably 10 nm or less). On the other hand, in the case where the crystalline orientation control layer 4 is formed of a magnetic material, the thickness thereof is set to be not less than 3 nm nor more than 10 nm.

Hereinafter, a description will be given of the result of investigating magnetic characteristics of the magnetic recording medium according to this embodiment. In this magnetic recording medium, as shown in FIG. 1, formed on the glass substrate 1 are the first soft magnetic layer (CoZrNb, 25 nm in thickness) 2a, the non-magnetic spacer layer (Ru, 0.7 nm in thickness) 2b, the second soft magnetic layer (CoZrNb, x nm in thickness) 2c, the seed layer (FeCoB, y nm in thickness) 3, the crystalline orientation control layer (NiFeCr, 5 nm in thickness) 4, the non-magnetic underlying layer (Ru, 20 nm in thickness) 5, the first recording layer (CoCrPt—SiO₂, 11 nm in thickness) 6, the second recording layer (CoCrPtB, 8 nm in thickness) 7, and the protective layer (CN, 4 nm in thickness) 8. It should be noted that the thickness x (nm) of the second soft magnetic layer 2c and the thickness y (nm) of the FeCoB seed layer 3 are determined on the basis of the following equation (1):
x(nm)·Bsa+y·Bsb=25 nm·Bsc (1)

Here, Bsa is the saturation flux density of the second soft magnetic layer 2c, Bsb is the saturation flux density of the FeCoB seed layer 3, and Bsc is the saturation flux density of the first soft magnetic layer 2a. If the thicknesses of the first and second soft magnetic layers 2a and 2c and the FeCoB seed layer 3 are determined so that the above-described relationship can be satisfied, noise (spike noise) from the under layer 2 can be prevented from affecting electromagnetic conversion characteristics.

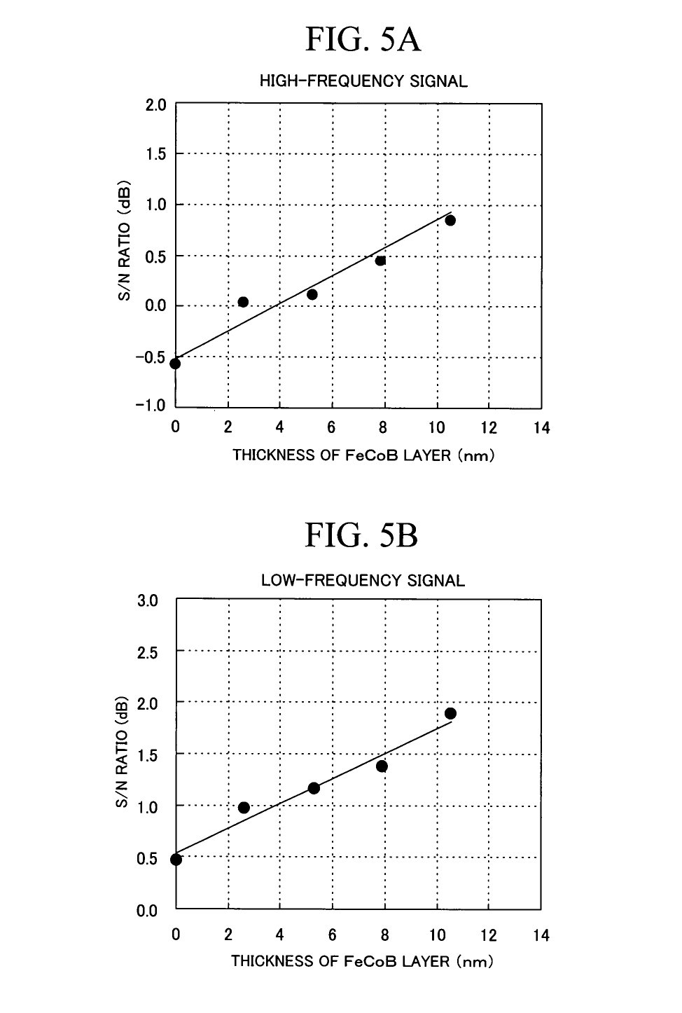

FIG. 5A is a diagram showing the relationship between the thickness of the FeCoB seed layer 3 and the S/N ratio for the case where a high-frequency signal is read. FIG. 5B is a diagram showing the relationship between the thickness of the FeCoB seed layer 3 and the S/N ratio for the case where a low-frequency signal is read. From these FIGS. 5A and 5B, it can be seen that the S/N ratio is improved as the thickness of the FeCoB seed layer 3 increases. For example, the S/N ratio is improved by 1 dB or more compared to that of the conventional one by setting the thickness of the FeCoB seed layer 3 to be 3 nm or more. It should be noted, however, that as described previously, it is difficult to thickly form the FeCoB seed layer 3, and manufacturing costs become significantly high if the thickness thereof exceeds 20 nm. Accordingly, the thickness of the FeCoB seed layer 3 is preferably set to 20 nm or less.

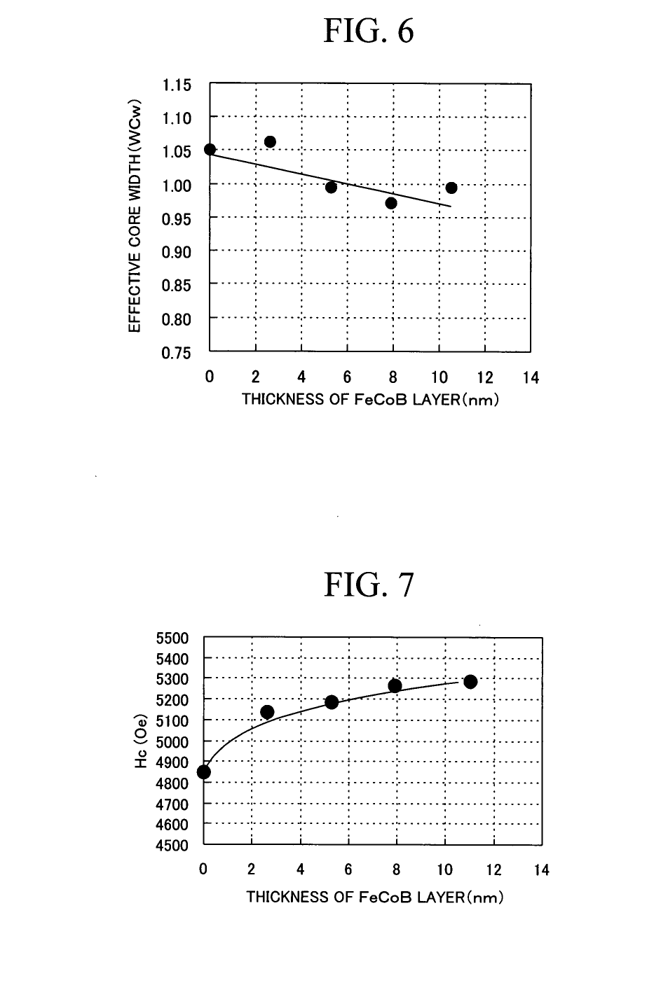

FIG. 6 is a diagram showing the relationship between the thickness of the FeCoB seed layer 3 and the effective write core width (WCw). As shown in FIG. 6, the larger the thickness of the FeCoB seed layer 3 is, the smaller the effective write core width is.

FIG. 7 is a diagram showing the relationship between the thickness of the FeCoB seed layer 3 and the coercive force Hc. As shown in FIG. 7, the larger the thickness of the FeCoB seed layer 3 is, the higher the coercive force Hc is.

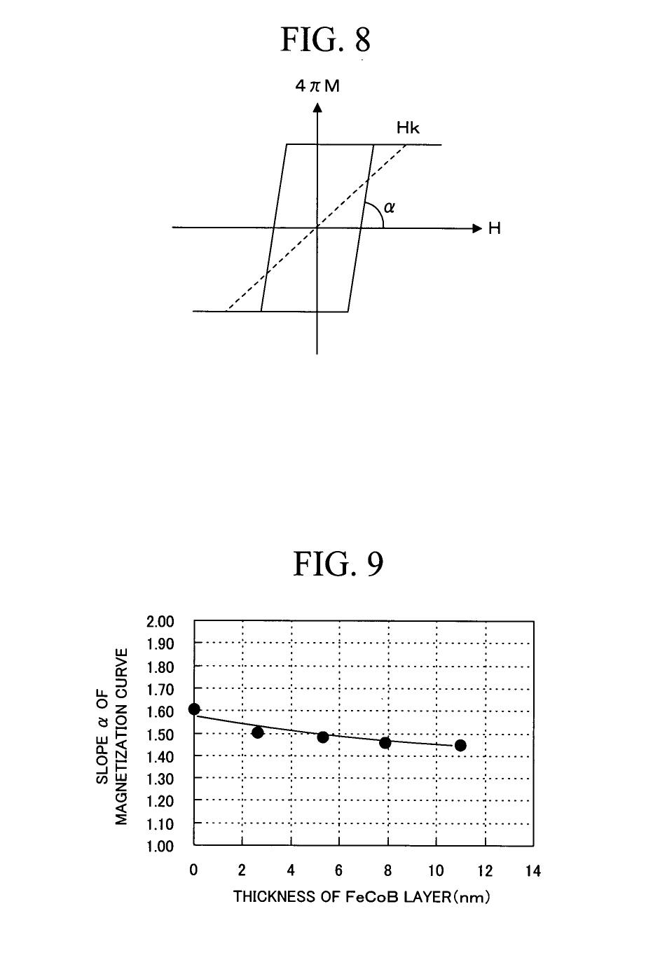

FIG. 8 is a diagram showing magnetization curves of the recording layers with a magnetic field H on the horizontal axis and a magnetization 4πM on the vertical axis. In FIG. 8, the solid line represents the magnetization curve for the case where a magnetic field is applied to the recording layers in the perpendicular direction, and the dashed line represents the magnetization curve for the case where a magnetic field is applied to the recording layers in the in-plane direction. A value at which the magnetic field saturates on the magnetization curve represented by this dashed line is the anisotropy field Hk. In FIG. 8, α is the angle formed by the horizontal axis and the magnetization curve represented by the solid lines, i.e., the slope of the magnetization curve (also referred to as the slope of a flux reversal region). It can be said that the smaller the slope α of the magnetization curve is, the larger the anisotropy field Hk is.

FIG. 9 is a diagram showing the relationship between the thickness of the FeCoB seed layer 3 and the slope α of the magnetization curve. From FIG. 9, it can be seen that the larger the thickness of the FeCoB seed layer 3 is, the smaller the slope α of the magnetization curve is. That is, from FIG. 9, it can be seen that the larger the thickness of the FeCoB seed layer 3 is, the larger the anisotropy field Hk is.

From these, it is obvious that the present invention is useful in improving the recording density of a perpendicular magnetic recording medium.

(Magnetic Recording Device)

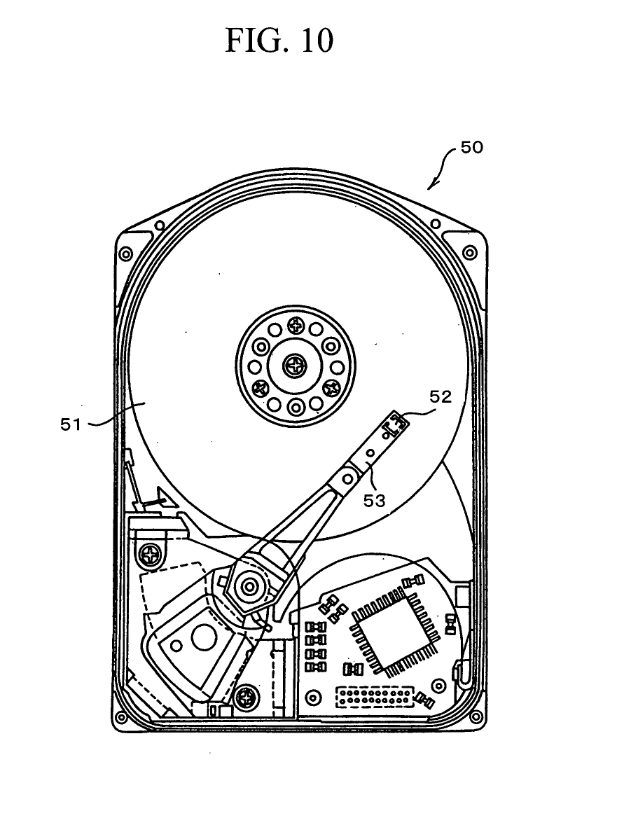

FIG. 10 is a plan view showing a magnetic recording device according to the present invention.

A magnetic recording device 50 includes, in a casing thereof, a disk-shaped magnetic recording medium (magnetic disk) 51, a spindle motor (not shown) for rotating the magnetic disk 51, a magnetic head (slider) 52 for writing and reading data, a suspension 53 for holding the magnetic head 52, and an actuator (not shown) for driving and controlling the suspension 53 in the radial direction of the magnetic disk 51. The magnetic recording medium 51 has the structure described in the aforementioned embodiment.

When the magnetic recording medium 51 is rotated by the spindle motor at a high speed, the magnetic head 52 floats slightly above the magnetic recording medium 51 due to airflow generated by the rotation of the magnetic recording medium 51. The magnetic head 52 is moved by the actuator in the radial direction of the magnetic recording medium 51, and data is written to or read from the magnetic recording medium 51.

The magnetic head 52 includes a write head used for writing data and a read head used for reading data. As the read head, for example, a magnetoresistive sensor such as a giant magneto resistive (GMR) element or a tunneling magneto resistive (TuMR) element is used.

Since the magnetic recording medium 51 having the aforementioned structure is used in the magnetic recording device constituted as described above, data can be recorded at high density in the magnetic recording device.

What is claimed is:

1. A magnetic recording medium comprising:
a substrate;
an under layer formed on the substrate and made of a soft magnetic material;
a seed layer formed on the under layer and made of FeCoB;
a crystalline orientation control layer which is formed on the seed layer, and which has a face-centered cubic lattice (fcc) structure;
an underlying layer formed on the crystalline orientation control layer and made of a non-magnetic material; and
a recording layer which is formed on the underlying layer, and which magnetically records data.

2. The magnetic recording medium according to claim 1, wherein a thickness of the seed layer is not less than 3 nm nor more than 20 nm.

3. The magnetic recording medium according to claim 1, wherein a Boron concentration in the FeCoB constituting the seed layer is 10 at % or more.

4. The magnetic recording medium according to claim 1, wherein the seed layer is formed of any one of amorphous FeCoB and microcrystalline FeCoB.

5. The magnetic recording medium according to claim 1, wherein the crystalline orientation control layer is formed of an alloy containing at least one element of Ni, Fe, Co, Cu, Rh, Ir, Pd, Pt, Al, Au and Ag.

6. The magnetic recording medium according to claim 1, wherein a thickness of the crystalline orientation control layer is not less than 3 nm nor more than 20 nm.

7. The magnetic recording medium according to claim 1, wherein the seed layer is made of any one of an amorphous FeCo alloy and a microcrystalline FeCo alloy, each of which contains at least one element of Ni, Cr, Cu, Nb, Zr, Si, Ta and W, instead of the FeCoB.

8. The magnetic recording medium according to claim 1, wherein the recording layer comprises a first recording layer and a second recording layer formed on the first recording layer, the first recording layer having a granular structure, and the second recording layer having a non-granular structure.

9. The magnetic recording medium according to claim 8, wherein the first recording layer has a larger anisotropy field Hk and a smaller magnetization curve slope α than the second recording layer.

10. The magnetic recording medium according to claim 1, wherein the under layer comprises a first soft magnetic layer, a non-magnetic spacer layer formed on the first soft magnetic layer, and a second soft magnetic layer formed on the non-magnetic spacer layer.

11. The magnetic recording medium according to claim 10, wherein magnetization directions of the first and second soft magnetic layers are opposite to each other.

12. The magnetic recording medium according to claim 10, wherein
an equation, x·Bsa+y·Bsb=c·Bsc, is satisfied,
where x is a thickness of the second soft magnetic layer, Bsa is a saturation flux density thereof, y is a thickness of the seed layer, Bsb is a saturation flux density thereof, c is a thickness of the first soft magnetic layer, and Bsc is a saturation flux density thereof,

13. The magnetic recording medium according to claim 1, wherein a thickness of the under layer is not less than 10 nm nor more than 100 nm.

14. A method of manufacturing a magnetic recording medium, comprising the steps of:
forming an under layer made of a soft magnetic material on a substrate;
forming a seed layer made of FeCoB on the under layer;
forming a crystalline orientation control layer having a face-centered cubic lattice (fcc) structure on the seed layer;
forming an underlying layer made of a non-magnetic material on the crystalline orientation control layer; and
forming a recording layer on the underlying layer.

15. The method according to claim 14, wherein the CoFeB seed layer is formed to a thickness of not less than 3 nm nor more than 20 nm.

16. The method according to claim 14, wherein the crystalline orientation control layer is formed to a thickness of not less than 3 nm nor more than 20 nm.

17. The method according to claim 14, wherein, as the under layer, a first soft magnetic layer made of a soft magnetic material, a non-magnetic spacer layer made of a non-magnetic material, and a second soft magnetic layer made of a soft magnetic material are deposited in this order.

18. The method according to claim 14, wherein, as the recording layer, a first recording layer having a granular structure and a second recording layer having a non-granular structure are deposited in this order.

19. The method according to claim 14, wherein any one of an amorphous FeCo alloy layer and a microcrystalline FeCo alloy layer, to which at least one element of Ni, Cr, Cu, Nb, Zr, Si, Ta and W is added, is formed instead of the CoFeB seed layer.

20. A magnetic recording device comprising:
a magnetic head; and
a magnetic recording medium which the magnetic head can write data to and read data from,
wherein the magnetic recording medium comprising:
a substrate;
an under layer formed on the substrate and made of a soft magnetic material;
a seed layer formed on the under layer and made of FeCoB;
a crystalline orientation control layer which is formed on the seed layer, and which has a face-centered cubic lattice (fcc) structure;
an underlying layer formed on the crystalline orientation control layer and made of a non-magnetic material; and
a recording layer which is formed on the underlying layer, and which magnetically records data.
